(19) United States
(12) Patent Application Publication
(10) Pub. No.: US 2006/0039419 A1
(43) Pub. Date: Feb. 23, 2006

(54) Method and apparatus for laser trimming of resistors using ultrafast laser pulse from ultrafast laser oscillator operating in picosecond and femtosecond pulse widths

(76) Inventor: Tan Deshi, Wuhan (CN)

Correspondence Address: BIRCH STEWART KOLASCH & BIRCH, PO BOX 747, FALLS CHURCH, VA, 22040-0747, US

(21) Appl. No.: 11/203,428

(22) Filed: Aug. 15, 2005

Related U.S. Application Data
(60) Provisional application No. 60/601,653, filed on Aug. 16, 2004.

(51) Int. Cl. H01S 3/10

(52) U.S. Cl. 372/9

(57) ABSTRACT

The present invention relates to a method and apparatus for laser trimming of resistors in semiconductor applications using ultrafast laser pulse from diode pumped or CW pumped solid state mode locked ultrafast pulse laser oscillator without amplification. The invention disclosed has a means to avoid/reduce the cumulative heating effect to avoid machine quality degrading in multi shot ablation. The disclosed invention provides a cost effective and stable system for high volume manufacturing application. The disclosed invention is used for thick and thin film trimming. Ultrafast laser oscillator can be a called as femtosecond laser oscillator or a picosecond laser oscillator depending on the pulse with of the laser beam generated.

The present application claims the benefit of Provisional Application No. 60/601,653, filed on Aug. 16, 2005, the entire contents of which is incorporated herein by reference.

### TECHNICAL FIELD OF THE INVENTION

The present invention relates to a method and apparatus for laser trimming of resistors in semiconductor applications using ultrafast laser pulse, and more specifically it relates to using diode pumped or CW pumped solid state mode locked ultrafast pulse laser oscillator without amplification.

### BACKGROUND OF THE INVENTION

Amplified short pulse laser of pulse width 100 picosecond to 10 femtosecond are being used in general applications to overcome the problem of long pulse laser. The advantage of short pulse lasers in comparison to long pulse laser are
Since the duration of short pulse laser is shorter than the heat dissipation time, the energy does not have the time to diffuse away and hence there is minimal or no heat affected zone and micro cracks.
There is negligible thermal conduction beyond the ablated region resulting in negligible stress or shock to surrounding material.
Since there is minimal or no melt phase in short pulse laser processing, there is no splattering of material onto the surrounding surface.
There is no damage caused to the adjacent structure since no heat is transferred to the surrounding material. There are no undesirable changes in electrical or physical characteristic of the material surrounding the target material.
No recast layer present along the laser cut side walls, which is vital for semiconductor application.
Eliminates the need for any ancillary techniques to remove the recast material within the kerf or on the surface
The surface debris present does not bond with the substrate and are easy to be removed by conventional washing techniques.
Machined feature size can be significantly smaller than the focused laser spot size of the laser beam and hence the feature size is not limited by the laser wavelength.

Short pulse laser can be broadly divided in to two categories
1. femtosecond pulse with laser (ranging from 10 fs-1 ps)
2. Pico second pulse width laser (ranging from 1 ps-100 ps)

The femtosecond laser system (which is generally a Ti-sapphire laser) generally consist of a mode locked femtosecond oscillator module, which generates and delivers femtosecond laser pulse of in the order of nanojoule pulse energy and 10-200 MHz repletion rate. The low energy pulse is stretched in time prior to amplification. Generally the pulse is stretched to Pico second pulse width in a pulse stretcher module, using a dispersive optical device such as a grating. The resultant stretched beam is then amplified by several orders of magnitude in the amplifier module, which is commonly called as regenerative amplifier or optical parameter amplifier (OPA). The pump lasers generally used to pump the gain medium in the amplifier are Q-switched Neodymium-yttrium-lithium-floride (Nd-YLF) laser or Nd:YAG laser with the help of diode pump laser or flash lamp type pumping. The repletion rate of the system is determined by the repletion rate of the pump laser. Alternatively if continuous pumping is used then the repetition rate of the system is determined by the optical switching within the regenerative amplifier. The resultant amplified laser pulse is of Ps pulse width is compressed to femtosecond pulse width in a compressor module. By this means femtosecond pulse of mille joules to micro joules of pulse energy of repletion rate 300 KHz to 500 Hz and average power less than 5 W are produced.

The amplified femtosecond pulse has been used widely for micro machining applications such as U.S. Pat. No. 6,720,519, U.S. Pat. No. 6,621,040, U.S. Pat. No. 6,727,458 and U.S. Pat. No. 6,677,552 suffers from following limitation, which prevents it from being employed in high volume manufacturing industrial applications.
The system is very unstable in terms of laser power and laser pointing stability. Laser stability is very essential in obtaining uniform machining quality (Ablated feature size) over the entire scan field.
The average laser power is very low to meet the industrial throughput
The Amplified femtosecond laser technology is very expensive, which will increase the manufacturing cost considerably.
The down time of the system is high to the complexity of the laser system
Large floor space of the laser system
Very poor feature size and depth controllability due to laser power fluctuation
Experiences and trained profession are required for the maintenance of the system

In contrast a amplified pico second laser system comprise of a pico second oscillator, which delivers picosecond laser of nanojoules pulse energy and is amplified by a amplifier. The pump lasers generally used to pump the gain medium in the amplifier are Q-switched Neodymium-yttrium-lithium-floride (Nd-YLF) laser or Nd:YAG laser with the help of diode pump laser or flash lamp type pumping. The repletion rate of the system is determined by the repletion rate of the pump laser. Alternatively if continuous pumping is used then the repetition rate of the system is determined by the optical switching within the regenerative amplifier. The resultant amplified pulse has repletion rate ranging from 500 Hz to 300 KHz of average power 1 to 10 W. Although amplified picosecond laser is simple and compact in comparison to amplified femtosecond laser but has the following limitations, which prevents it from being used for high volume manufacturing applications in industry,
The Amplified picosecond laser also more stable than an amplified femtosecond laser system, it is still unstable in terms of laser power and laser pointing stability to meet the needs for industrial high volume manufacturing applications. Laser stability is very essential in obtaining uniform machining quality (Ablated feature size) over the entire scan field.
The Amplified picosecond femtosecond laser technology also cheaper than amplified femtosecond laser system it is still expensive, which will increase the manufacturing cost considerably.
Very poor feature size and depth controllability due to laser power fluctuation
The down time of the system is high.
Large floor space of the laser system
Experiences and trained profession are required for the maintenance of the system

Femtosecond laser with very low fluency is a promising machining tool for direct ablating of sub-micron structures. Fundamental pulses emitting from oscillator can be used to create nano-features. But due to short time gap between the successive pulses, there is a considerable degrade in the machining quality, which may be explained as below.
At the end of the irradiation of an individual laser pulse, surface temperature rises to Tₘₐₓ. Due to thermal diffusion, the surface temperature decays slowly and eventually reduces to the environment temperature T₀. The time span of the thermal diffusion τ_{diffusion} can be determined by the one-dimensional homogeneous thermal diffusion equation. In the case of multi-shot ablation, if the successive pulse arrives before τ_{diffusion} (t<τ_{diffusion}), the uncompleted heat dissipation will enhance the environment temperature. The environment temperature after n laser shots for a pulse separation of t at a time just before the next (or (n+1)th) shot can be expressed by
T₀(n)=T₀+nδT, where, δT is the temperature rise due to un-dissipated heat at the end of a pulse temporal separation.
The actual surface temperature Tₘₐₓ(n) after n successive pulses can be written as
   Tₘₐₓ(n)=T₀(n)+Tₘₐₓ

The enhanced surface temperature of the ablation front will cause over heating and deteriorate the quality of ablation. In the case of via drilling application, such over heating deteriorate the geometry of via, causing barrel at the bottom of the hole.

The longer the time between successive pulses, the less is the effect of the thermal coupling enhancing the surface temperature. When pulse separation t is long enough that the heat diffusion outranges the thermal coupling, the machining quality of multi-shot ablation will be as good as that of single-shot ablation.

In fact, thermal coupling effect of multi-shot ablation was observed not only for nano-second pulses but also for ultrafast laser pulses. Fuerbach [1], reported that to avoid degrading of machine precision due to heat accumulating 1 μs pulse separation should be given for femtosecond pulses ablation of glass.

U.S. Pat. No. 6,552,301 describes the use of high repletion rate pulse either amplified or un-amplified for micromachining. The pulse to pulse separation time is less than the relaxation time/diffusion time of the ablated material so that there is a cumulative heating effect as described above. By this process the subsequent pulses arrive before the sample surface dissipate the heat generated by the previous pulse and relax to the state of the underlying bulk material. Although the U.S. patent shows a general application of using ultrafast pulse laser directly for micro machining, due to cumulative heating effect there is temperature rise around the focal area and hence there will be considerable heat accumulation surrounding the ablated feature. These effect due to heat accumulation increases with the increase in the pulse width, say from 1 fs to 100 ps. Also machining with ultrafast pulse laser directly from oscillator, the feature quality is degraded. Following are some of the drawbacks due to the effect
Difficult to be used for nanoscale maching application due to heat accumulation and hence there is broadening of the feature at the focused spot.
Surrounding area will be damaged due to heat accumulation, which is not accepted in many semiconductor applications.
More debris inside and around the ablated feature and may require considerable post processing.
Barrel shape at the bottom of the hole in via drilling applications
Very poor quality of the ablated feature

Laser Trimming of Resistors

High precision resistors are responsible for the functionality, capability and reliability of modern hybrid IC's. In practice, however, high precision resistors are difficult to manufacture. Laser resistor trimming on wafer level is the most popular method of individually tailoring each die on a silicon wafer to meet precise resistor specifications.

Conventional laser systems such as Nd:YLF or Nd:YAG of nanosecond pulse width are generally employed for processing targets such as film resistos, inductors, or capacitors, in circuits formed on ceramic, glass, silicon or other substrates as described in U.S. Pat. No. 5,685,995 by Sun et al. Passive, functional, or activated resistor trimming are the few types of laser processing to trim the resistance values of film resistor. The laser trimming process by Nd:YLF or Nd:YAG laser of nanosecond pulse width has an impact on long term stability and quality of each trimmed resistor. The disadvantages caused are,
Heat affected zone next to each cut path due to long pulse with of the laser beam in nanosecond time scale and hence the zone is unstable.
Micro cracks are formed in the cut zone and near the cut zone.
Debris and recast molten material are formed in the cut zone and near the cut zone.
The active circuits near the cut zone can be damaged due to the long pulse laser ablation.

Due to the above limitations the resistance will change with time depending on the heat affected zone, crack formations with time and molten recast material and debris. Since the concrete value of the heat affected zone, crack formation, recast layer etc is unknown, it is impossible to calculate the drift amount in the resistor value. So even a resistor is trimmed to high precision, the resistor value will be ruined by the post-trim drift. Also the ablated feature size vary by more than 20% due to nanosecond laser pulse width, which makes it even more difficult to determine the post trim drift.

In order to minimize the damage to the silicon substrate and to reduce the settling time of the resistor, nanosecond laser of unconventional wavelength of 1.3 micrometer was used to trim films and devices as disclosed in U.S. Pat. Nos. 5,569,398, 5,685,995, and 5,808,272 of Sun and Swenson. Although the damage to the silicon substrate is minimized but the invention suffers from the limitation of nanosecond laser pulse such as damage to the surrounding layers and devices, micro cracks, debris, molten material, variation on the ablated feature size along the cut zone etc. International patent application No WO 99/40591 of sun and Swenson describes the use of Gaussian ultraviolet (UV) Gaussian laser beam for trimming of resistors also suffer from the limitation of nanosecond laser pulse described above. Additionally the trimming process is relatively slow because the laser parameter must be precisely controlled to avoid complete removal of the resistor film. U.S. Pat. No. 6,534,743 by Swenson et al discloses the use uniform UV laser spot rather than Gaussian beam for trimming of resistors, to minimize micro cracking. Although U.S. Pat. No. 6,534,743 by Swenson et al minimizes the micro crack formation but is limited by the draw backs of nanosecond laser ablation and the complexity of beam shaping to obtain a uniform beam profile. Additionally it is difficult to obtain small focused spot size with uniform beam profile, which is demanded by many resistor trimming applications.

### SUMMARY OF THE INVENTION

The object of the present invention is to provide improved method and apparatus for micro/nano machining and to ameliorate the aforesaid deficiencies of the prior art by using ultrafast pulse generated directly from the laser oscillator. The laser oscillators are mode locked diode pumped solid state laser system, which is stable and compact. The pulse laser beam having a pulse width of 1 fs to 100 ps of repletion rate from 1 MHz to 400 MHz is controlled by electro optic modulator or acousto optic modulator.

The modulated pulse is expanded to required beam diameter by using combination of positive and negative lens to act as a telescope. Varying the diameter of the laser beam the focused laser spot size can be varied. The pulsed laser beam scanned by a 2 axis galvanometer scanner to scan the pulse laser beam on the surface of the work piece in a predetermined pattern. The scanning beam can be focused on a work piece using a focusing unit or lens, which is preferably a scanning lens, telecentic lens, F-θ lens, or a the like, positioned a distance from the scanning mirror approximately equal to the front focal length (forward working distance) of the focusing lens. The work piece is preferably positioned at approximately the back focal length (back working distance) of the focusing lens.

In another aspect of the invention, the modulator controls the laser pulse to minimize the cumulative heating effect and to improve the machining quality. In addition to pulse control the modulator controls the pulse energy and function as a shutter to on and off the laser pulse when required.

In another aspect of the invention, the cumulative heating effect can be minimized or eliminated by using a gas or liquid assist. Due to the cooling effect of the assisted gas or liquid it is possible to minimize the cumulative heating effect even at high repletion rate. Also the machining quality and efficiency of processing is improved on using assisted gas or liquid.

In another aspect of the invention, the cumulative heating effect, quality of the machined feature and efficiency of the process also depends on the scanning speed of the laser. The scanning speed is controlled depending on the repletion rate of the laser beam, the ablated feature size and the type of gas or liquid assist used.

In another aspect of present invention, it is possible to producing feature size of less than one twentieth of the focused spot size of the ultrafast pulse laser beam. This can be achieved by precisely controlling the laser threshold fluence slightly above the ablation threshold of the material and by precisely controlling the number of pulse and the duration between the pulses (minimizing or eliminating the cumulative heating effect) using the pulse modulation means disclosed in this invention. In addition the stability of the laser pulse from the ultrafast laser oscillator plays a vital role in machining feature of desired size with repeatability and precision.

In another aspect of the present invention, the pulse energy plays a vital role in micro and nano processing with high quality. The pulse energy required to ablate a feature depends on the depth of ablation, repeatability of feature size required and the feature quality. The maximum depth that can be generated for a given focused spot size of the laser beam depends on the pulse energy. As the ablated feature becomes deeper it is difficult to remove the ablated material from the hole and hence the ablated material absorbs the energy of the subsequent pulse. Also the uncertainty in the feature size obtained will depend on the number of pulse required to ablate the required feature. Due to the topography generated and debris deposited in the crater by the ablation of the first pulse the absorption of the successive pulse is different due to the defects generated in the previous pulse, scattering of the laser beam etc. Due to the above mechanism the ablation threshold of the successive pulse may be vary. The uncertainly in the diameter of ablated feature increases with increase in the number of pulse. Also, higher pulse energy generates sufficient pressure for ejecting the debris out of the carter and hence the successive pulse will interact with the fresh substrate. This results in improved top surface and inner wall quality of the ablated feature. Hence it is advantageous to higher pulse energy and lower number of pulse to ablate a required feature.

In another aspect of the invention, the effect of wavelength on the cutting efficiency and stability of micron and nano processing using laser pulse from ultrafast laser oscillator is disclosed. In ultrafast laser processing the wavelength of the laser beam does not have a major impact on the threshold fluence of the material as in case of short pulse ablation in micron and nanosecond pulse width. Due to high peak power of the laser due to short pulse width, the protons are generated by the laser beam to start the ablation process rather than generated from the substrate. Hence absorption of the material at different wavelength does not have a major influence in its threshold fluence. Hence laser beam having the fundamental frequency will have higher cutting efficiency than the second harmonic frequency for a given focused spot size due to the higher average power from the ultrafast laser oscillator at fundamental laser frequency. Similarly, the laser beam having the second harmonic frequency will have higher cutting efficiency compared to third harmonic frequency due to the greater average power from the ultrafast laser oscillator at second harmonic frequency. Also the stability of the laser beam will deteriorate with the reduction in wave length by frequency doubling and tripling, due to increase in the optical components and the sensitivity of the frequency doubling and tripling crystal to environmental factors such as temperature. Hence repeatability in feature size and position accuracy may deteriorate compared to the fundamental frequency from the ultrafast laser oscillator by frequency doubling and tripling. Also the cost of the system may increase by frequency doubling and tripling due to addition of more optical components. In spite of the drawbacks of using frequency doubled and tripled laser pulse, some applications may demand the use of shorter wavelength to achieve smaller feature size and in sensitive material processing.

In another aspect of the present invention, a polarization conversion module is used to vary the polarization state of the laser beam along the axis. The modules uses a combination of a telescopic arrangement with a retardation plate or birefringent material in-between them. The resultant polarization state of the beam can be a partially or fully radial polarization state. This enables reduced focused spot size and improvement in the cutting efficiency and quality compared to linear and circularly polarized laser beams.

In another aspect of the present invention a piezo scanner is used for scanning the laser beam in two axes rather than a galvanometer scanner. This eliminates the distortion created at the image field due to common pivot point of scanning on two axes. Also the position accuracy and resolution is enhanced.

In another aspect of the present invention, a beam shaping module is introduced to change the profile of the laser beam to the desired profile using a combination of a MDT element and a quarter wave plate. By carefully selecting the beam diameter and the length of the MDT element the beam profile is varied for selective material removal and via drilling application

The method and apparatus of the present invention is capable of trimming resistor using ultrafast laser pulse from the oscillator. In ultrafast laser processing the threshold fluence of the material is clearly defined. Hence by controlling the pulsed laser fluence, the resistive material can be selectively removed without ablating the substrate. Resistive film layer can be a thick film or a thin film layer depending on the application. Ultrafast laser pulse trim the resistive layer to the desired value without ablating or damaging the substrate material. The overlying resistive layer can be removed in one scan cycle or in multiple scan cycle depending on the thickness of the resistive film, desired trim kerf, accuracy of trimming etc. The resistive layer can vary in thickness from few micrometers to few nanometers.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is an illustration showing the laser apparatus for micro and nano processing using ultrafast laser pulse from the oscillator.

FIG. 2 is an illustration showing the apparatus to modulate the ultrafast laser pulse from the oscillator using electro optic modulator.

FIG. 3 is an illustration showing the mechanism of eliminating the successive ultrafast laser pulse to reduce the repetition rate by using electro optic modulator.

FIG. 4 is an illustration showing the introduction of a time gap between groups of laser pulse using electro optic modulator.

FIG. 5 is an illustration showing the control mechanism of photo detector, electro optic modulator, XYZ translation stage, galvanometer scanner and the imaging system by a processor control.

FIG. 6 is an illustration showing the apparatus to modulate the ultrafast laser pulse from the oscillator using acousto optic modulator.

FIG. 7 is an illustration showing the mechanism of eliminating the successive ultrafast laser pulse to reduce the repetition rate by using acousto optic modulator.

FIG. 8 is an illustration showing the introduction of a time gap between groups of laser pulse using acousto optic modulator.

FIG. 9 is an illustration showing the control mechanism of photo detector, Acousto optic modulator, XYZ translation stage, galvanometer scanner and the imaging system by a processor control.

FIG. 10 is an illustration showing the 0% overlap between consecutive ablated laser spot.

FIG. 10A is an illustration showing the edge quality of the ablated feature with 0% overlap between consecutive ablated laser spot.

FIG. 11 is an illustration showing the 50% overlap between consecutive ablated laser spot.

FIG. 11A is an illustration showing the edge quality of the ablated feature with 50% overlap between consecutive ablated laser spot.

FIG. 12 is an illustration showing the edge quality of the ablated feature with 90% overlap between consecutive ablated laser spot.

FIG. 13 is an illustration showing the Gaussian energy distribution of machining spot.

FIG. 14 is a graph showing the average laser power at different laser wavelength for a typical picosecond laser oscillator.

FIG. 15 is an illustration of the cross section on a resistor film on a substrate.

FIG. 16 is an illustration of cross section of trimmed resistor film without damaging the underlying substrate using laser from ultrafast laser oscillator.

FIG. 17 is an illustration of trimming of resistor in a single laser pass/cycle using laser from ultrafast laser oscillator.

FIG. 18 is an illustration of trimming of resistor in a multiple laser pass/cycle using laser from ultrafast laser oscillator.

FIG. 19 is an illustration showing a polarization conversion module to change the polarization state of the ultrafast laser beam.

FIG. 20 is an illustration showing a beam shaping module to change the profile of ultrafast laser beam

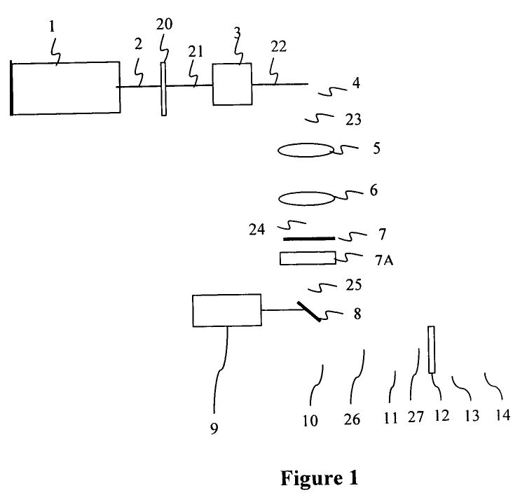

### DETAILED DESCRIPTION OF THE DRAWINGS

The object of the present invention is to provide improved method and apparatus for micro/nano machining and to ameliorate the aforesaid deficiencies of the prior art by using ultrafast pulse generated directly from the laser oscillator. The laser oscillators are mode locked diode pumped solid state laser system, which is stable and compact. The pulse laser beam having a pulse width of 1 fs to 100 ps of repletion rate from 1 MHz to 400 MHz is controlled by electro optic modulator or acousto optic modulator.

The modulated pulse is expanded to required beam diameter by using combination of positive and negative lens to act as a telescope. Varying the diameter of the laser beam the focused laser spot size can be varied. The pulsed laser beam scanned by a 2 axis galvanometer scanner to scan the pulse laser beam on the surface of the work piece in a predetermined pattern. The scanning beam can be focused on a work piece using a focusing unit or lens, which is preferably a scanning lens, telecentic lens, F-θ lens, or a the like, positioned a distance from the scanning mirror approximately equal to the front focal length (forward working distance) of the focusing lens. The work piece is preferably positioned at approximately the back focal length (back working distance) of the focusing lens.

The modulator controls the laser pulse to minimize the cumulative heating effect and to improve the machining quality. In addition to pulse control the modulator controls the pulse energy and function as a shutter to on and off the laser pulse when required.

The cumulative heating effect can be minimized or eliminated by using a gas or liquid assist. Due to the cooling effect of the assisted gas or liquid it is possible to minimize the cumulative heating effect even at high repletion rate. Also the machining quality and efficiency of processing is improved on using assisted gas or liquid.

The cumulative heating effect, quality of the machined feature and efficiency of the process also depends on the scanning speed of the laser. The scanning speed is controlled depending on the repletion rate of the laser beam, the ablated feature size and the type of gas or liquid assist used.

In addition the, the present invention is capable of producing feature size of less than one twentieth of the focused spot size of the ultrafast pulse laser beam. This can be achieved by precisely controlling the laser threshold fluence slightly above the ablation threshold of the material and by precisely controlling the number of pulse and the duration between the pulses (minimizing or eliminating the cumulative heating effect) using the pulse modulation means disclosed in this invention. In addition the stability of the laser pulse from the ultrafast laser oscillator plays a vital role in machining feature of desired size with repeatability and precision.

In addition it is disclosed in the present invention that the Pulse energy plays a vital role in micro and nano processing with high quality. The pulse energy required to ablate a feature depends on the depth of ablation, repeatability of feature size required and the feature quality. The maximum depth that can be generated for a given focused spot size of the laser beam depends on the pulse energy. As the ablated feature becomes deeper it is difficult to remove the ablated material from the hole and hence the ablated material absorbs the energy of the subsequent pulse. Also the uncertainty in the feature size obtained will depend on the number of pulse required to ablate the required feature. Due to the topography generated and debris deposited in the crater by the ablation of the first pulse the absorption of the successive pulse is different due to the defects generated in the previous pulse, scattering of the laser beam etc. Due to the above mechanism the ablation threshold of the successive pulse may be vary. The uncertainly in the diameter of ablated feature increases with increase in the number of pulse. Also, higher pulse energy generates sufficient pressure for ejecting the debris out of the carter and hence the successive pulse will interact with the fresh substrate. This results in improved top surface and inner wall quality of the ablated feature. Hence it is advantageous to higher pulse energy and lower number of pulse to ablate a required feature.

The invention discloses the effect of wavelength on the cutting efficiency and stability of micron and nano processing using laser pulse from ultrafast laser oscillator. In ultrafast laser processing the wavelength of the laser beam does not have a major impact on the threshold fluence of the material as in case of short pulse ablation in micron and nanosecond pulse width. Due to high peak power of the laser due to short pulse width, the protons are generated by the laser beam to start the ablation process rather than generated from the substrate. Hence absorption of the material at different wavelength does not have a major influence in its threshold fluence. Hence laser beam having the fundamental frequency will have higher cutting efficiency than the second harmonic frequency for a given focused spot size due to the higher average power from the ultrafast laser oscillator at fundamental laser frequency.

Similarly, the laser beam having the second harmonic frequency will have higher cutting efficiency compared to third harmonic frequency due to the greater average power from the ultrafast laser oscillator at second harmonic frequency. Also the stability of the laser beam will deteriorate with the reduction in wave length by frequency doubling and tripling, due to increase in the optical components and the sensitivity of the frequency doubling and tripling crystal to environmental factors such as temperature. Hence repeatability in feature size and position accuracy may deteriorate compared to the fundamental frequency from the ultrafast laser oscillator by frequency doubling and tripling. Also the cost of the system may increase by frequency doubling and tripling due to addition of more optical components. In spite of the drawbacks of using frequency doubled and tripled laser pulse, some applications may demand the use of shorter wavelength to achieve smaller feature size and in sensitive material processing.

In another aspect of the present invention, a polarization conversion module is used to vary the polarization state of the laser beam along the axis. The modules uses a combination of a telescopic arrangement with a retardation plate or birefringent material in-between them. The resultant polarization state of the beam can be a partially or fully radial polarization state. This enables reduced focused spot size and improvement in the cutting efficiency and quality compared to linear and circularly polarized laser beams.

In another aspect of the present invention a piezo scanner is used for scanning the laser beam in two axes rather than a galvanometer scanner. This eliminates the distortion created at the image field due to common pivot point of scanning on two axes. Also the position accuracy and resolution is enhanced.

In another aspect of the present invention, a beam shaping module is introduced to change the profile of the laser beam to the desired profile using a combination of a MDT element and a quarter wave plate. By carefully selecting the beam diameter and the length of the MDT element the beam profile is varied for selective material removal and via drilling application

The method and apparatus of the present invention is capable of trimming resistor using ultrafast laser pulse from the oscillator. In ultrafast laser processing the threshold fluence of the material is clearly defined. Hence by controlling the pulsed laser fluence, the resistive material can be selectively removed without ablating the substrate. Resistive film layer can be a thick film or a thin film layer depending on the application. Ultrafast laser pulse trim the resistive layer to the desired value without ablating or damaging the substrate material. The overlying resistive layer can be removed in one scan cycle or in multiple scan cycle depending on the thickness of the resistive film, desired trim kerf, accuracy of trimming etc. The resistive layer can vary in thickness from few micrometers to few nanometers.

Exemplary embodiment of the present invention will now be described in greater detail in reference to the figures.

One embodiment of the present invention is the method and apparatus for micron and nano processing using ultrafast laser pulse directly from the laser oscillator. The ultrafast laser oscillator 1 generates laser pulse of pulse with 1 fs-100 ps. The laser pulse is preferably of the wavelength 1200-233 nm and repletion rate from 1 MHz to 400 MHz. Also the laser beam is collimated and of liner or circular polarization state. The laser beam 20 incidents substantially normally on a wave plate 2, which is preferably a half wave or quarter wave plate to change the polarization state of the incident laser beam 20. The laser pulse 21 is modulated by beam modulating means 3. The modulated laser pulse 22 is deflected by a mirror 4. The laser beam 23 is expanded or reduced in beam diameter by the optical lens 5 and 6, which are arranged and are of the type keplerian telescope (where optical lens 5 and 6 are positive lens) or Galilean telescope (where optical lens 5 is a negative lens and optical lens 6 is a positive lens for beam size expansion or vice versa for beam size reduction).

The expanded laser beam 24 is passed through a diaphragm 7 to cut the edge of the Gaussian beam and to improve the quality of the pulsed laser beam and then through a polarization conversion module 7A. The laser beam 25 is scanned in X and Y axis by a two axis galvanometer scanner 10 after passing through a mirror or polarizer 8. Camera 9 images the work piece through 8, to align the work piece to the laser beam and to monitor the machining process. The laser beam 26 from the galvanometer scanner 10 is focused by an optical lens 11, which is preferably a telecentric lens or f-theta lens or scan lens or confocal microscopy lens. The lens 11 is positioned at the forward working distance from the center of the two scanning mirrors in the galvanometer scanner 10. The work piece/substrate 13 is placed at a distance equal to the back working distance of the lens 11 from the back face/out put of the lens 11. A gas assist system comprising of one or more nozzle is positioned close to the work piece/substrate 13. Preferably the work piece/substrate 13 is placed on a three axis mechanical translational stage 14. The translational stage 14 translates with respect to the laser beam 27 during and after laser dicing of an area defined by a field of view of the scanning lens.

During the micro and nano processing using ultrafast laser pulse directly from oscillator, the laser beam 27 may be focused on the top surface of the substrate/wafer 13 or located inside the bulk of substrate material between the top and bottom surface of the substrate 13. The location of the focus of the beam 27 depends on the thickness of the substrate/wafer 13. Thicker the material the focus of the laser beam 27 is further inside the bulk of the substrate, away from the top surface of the substrate.

Depending on the pulse energy of the laser beam 27 from the ultrafast laser oscillator 1 and the thickness of the substrate/wafer 13, the laser beam 23 is expanded or reduced, thus varying the energy density of the laser beam at the focused spot. When the laser beam 23 is expanded in beam diameter, using combination of optical lens 5 and 6, the focused spot size reduces and hence increases the energy density at the focused laser spot. Alternatively, when the laser beam 23 is reduced in beam diameter, using the combination of optical lens 5 and 6, the focused spot size increases and hence reducing the energy density at the focused laser spot.

The laser oscillator 1 generates laser pulse of pulse width 1 fs to 100 ps and pulse repletion rate from 1 MHz to 400 MHz. The Fundamental wavelength of the laser beam ranges from 1200 nm to 700 nm, second harmonic wave length 600 nm-350 nm and third harmonics from 400 nm to 233 nm. The pulse energy generated from this oscillator depends on the repetition rate of the system, higher the repletion rate lower will be the pulse energy and vice versa. Generally the average power of the laser from the oscillator will be 0.2 W-30 W depending on the pulse width and wavelength of the laser. Laser with pulse width 1 fs to 200 fs have an average power of 0.2 W to 10 W depending on the pump laser power. Some of the commercially available ultrafst mode locked CW pumped solid state oscillators are Coherent Vitesse, Coherent Chameleon, Femtosource Scientific XL, Spectra Physics Mai-Tai etc. Similarly laser with pulse width 1 ps-100 ps have an average power 1 W-30 W at fundamental wavelength depending on the pump laser power. Some of the commercially available ultrafast mode locked diode pump solid state oscillators are Coherent paladin, Time Bandwidth Cheetah-X, Time Bandwidth Cougar, Lumera laser UPL-20, Time bandwidth Fortis.

Since the oscillator worked on diode pumped or CW pumped solid state technology and involve minimal optical components the system is highly stable for industrial high volume manufacturing applications. In ultrafast laser processing, the ablated feature size/machined feature size depends on the energy stability/noise of the laser. Based on Gaussian profile, for every 1% fluctuation in the laser fluence/laser energy there will be 16% fluctuation in the ablated/machined feature size in ultrafast laser processing. But most industrial application demand for strict feature size control within 1-5%. Also pointing stability becomes a very critical issue for machining feature in micron and nano scale industrial application. This stringent industrial requirement can be only be met by using laser pulse directly from ultrafast laser oscillator.

Hence, using laser pulse directly from ultrafast laser oscillator for micro/nano processing makes the ultrafast laser technology viable for high volume manufacturing industrial applications due to the following facts
The system is stable in terms of laser power and pulse to pulse energy due to Diode Pump Solid State (DPSS) laser technology and minimal optical components. The laser stability and the pulse to pulse energy stability and very critical in controlling and obtaining repeatability in ablated feature size.
Good laser pointing stability due to DPSS laser technology.
Good beam quality, which is essential for micro/nano processing.
The laser power is high enough to meet the industrial throughput in micro/nano processing application.
The system is simple and cost effective and reduces the manufacturing cost considerably.
Low cost of ownership due to efficient DPSS technology
The down time of the system is very low.
Very small floor space of the laser system

In spite of the salient features mentioned above, micro/nano processing by using laser pulse directly from ultrafast laser oscillators limited due to
Cumulative heating effect which results in poor machining quality
absence of shutter mechanism to on and off the laser at high speed
Absence of means to controlling the pulse energy.

To avoid surface modification around the structure which one actually wants to generate, thermal diffusion of the heat out of the focal volume must overcome the deposited\laser energy. In this case there is no temperature raise around the focal area and hence no cumulative heating effect is expected. Thus in order to minimize the cumulative heating effect in multi short ablation the pulse separation time t should be long enough that the heat diffusion outranges the thermal coupling. Following are some of the mean to minimizing the cumulative heating effect and to improving machining quality disclosed in this invention
controlling laser pulse from the ultrafast laser oscillator
Using gas assisted ablation.
Scanning the laser beam at a rate at which the each laser pulse irradiates at different spot.

This ensures that the machining precision after many laser shots does not degrade in comparison to single pulse damage spot.

Controlling the Laser Pulse from the Ultrafast Laser Oscillator:

Alternatively, the repetition rate can be reduced by increasing the resonator length and hence repletion rate as low as 5 MHz-10 MHz can be realized by increasing the resonator length. By reducing the pulse repetition rate the pulse energy can be increased, which increases the range of material that can be ablated and the feature size. The pulse energy, out of the mode locked oscillator can be calculated by
Ep=PA/R, where Ep is the pulse energy, PA is the average power and R, repetition rate of the system.

But to completely eliminate the cumulative heating effect and to improve the ablated feature quality the repletion rate should be reduced to less than 1 MHz, which means a resonator cavity length of 150 m, which is hard to realize. In order to further reduce the repletion rate some external pulse control means should be used. Also the pulse control means eliminates the need for shutter and pulse energy control mechanism.

Two type of pulse control means namely electro optic and acousto optic modulation system are disclosed in this invention to perform the following functions
Control the repletion rate,
Control the pulse energy
Operate as laser shutter to on and off the laser out put when required.

Controlling the Laser Pulse by Electro Optic Modulator:

Depending on the application electro optic modulator is called as pockels cells or Q-switch or pulse picker. The electro optic modulator is used in combination with a polarizing beam splitter or polarizer or prism for controlling the laser pulse. The electro optic modulator has the following specification for efficient pulse control
Short rise time in the range of 20 ns to 10 ps
Energy/power loss less than 10%
Clear aperture diameter: 2-10 mm

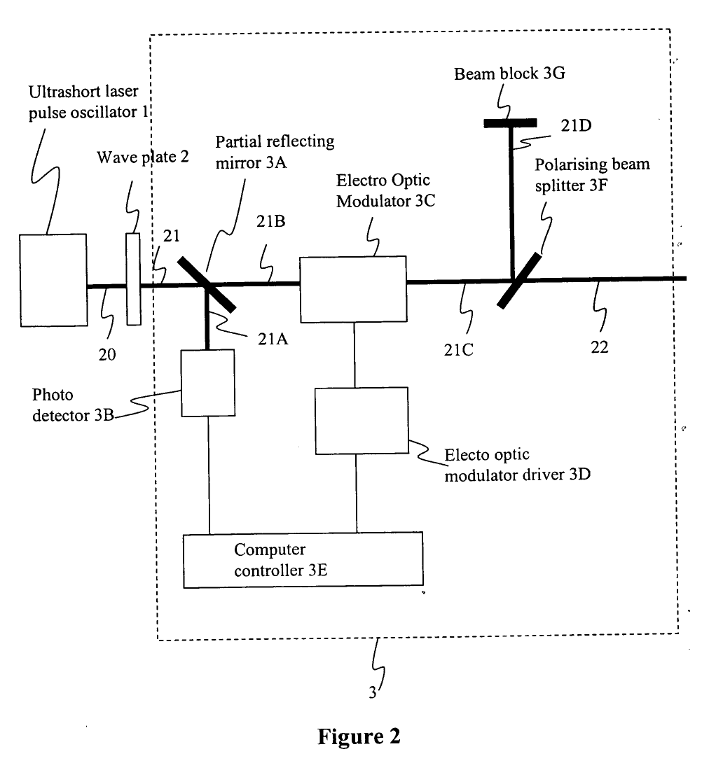

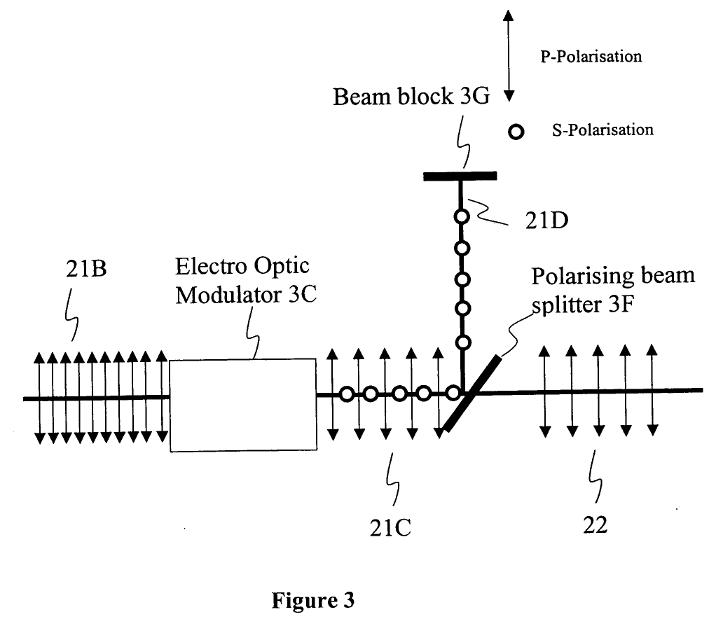

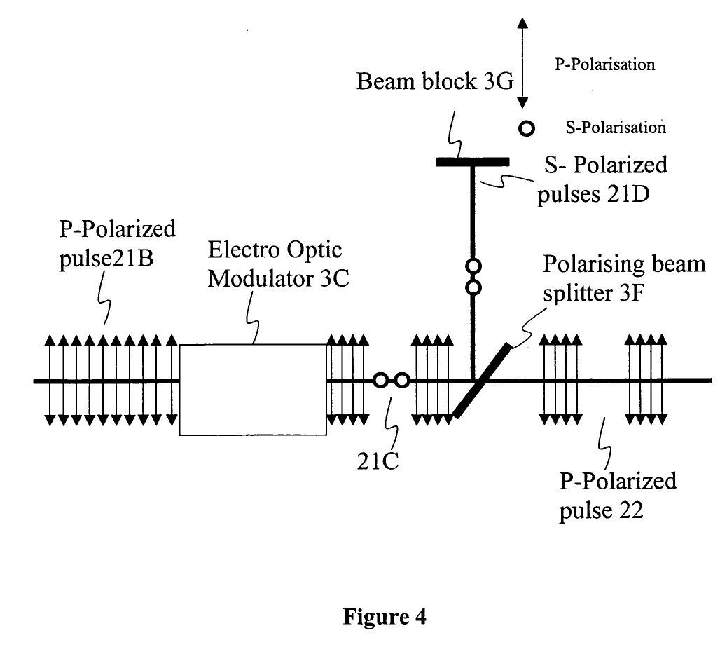

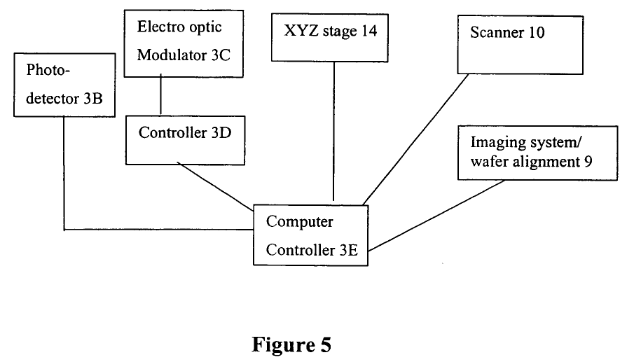

The antireflection coating and type of crystal in the modulator depend on the laser wavelength, which may vary depending on the application. The electro optic modulator is driven by a driver which can be computer controlled. On sending the trigger signal, which is preferably a voltage or power signal, to the electro optic modulator from the driver the polarization state of the laser beam is shifted from horizontal to vertical polarization or vice versa. Vertical and horizontal polarizations are also called as S and P polarizations. By changing the polarization the beam will be transmitted or deflected by the polarizing beam splitter or a polarizer or prism, thus acting like a high speed shutter and controlling the pulse. The deflected or transmitted beam can be used for processing but generally the transmitted beam is used for laser processing and the deflected beam is blocked by the beam blocking means. FIG. 2 shows the working mechanism of electro optic modulator for pulse control. The pulsed laser from the ultrafast laser oscillator 1, has a repletion rate of 5 MHz to 200 MHz pass through an electro optic modulator 3C at S or P-polarization state. The electro optic modulator 3C is driven by a driver 3D, which is controlled by a computer 3E. A fraction of the laser beam 21 (less than 1% of energy) is deflected by a partial coated mirror 3A on to a photo detector 3B is placed before the electro optic modulator as shown in the FIG. 2 to obtain the signal from beam 21A and to synchronize the on/off of the electro optic modulator 3C to avoid any clipping of laser pulse 21C. Due to the fast rise time of the electro optic modulator 3C, the polarization state of any individual pulse or a group of pulse can be shifted by 90 degrees to S or P polarization state respectively. On passing through the polarizing beam splitter 3F which is of the type plate polarizing beam splitter or cube polarizing beam splitter or polarizer or prism, the S and P polarized laser pulse are deflected at different angle. One of the beams 21D can be blocked by a beam blocking means 3G and the other beam 22 can be used for laser processing. FIG. 3 shows the electro optic modulator changing the polarization state of alternative pulses and FIG. 4 shows the electro optic modulator changing the polarization state of group of pulse. Thus by using electro optic modulator 3C in combination with a polarizing beam splitter 3F for controlling the laser pulse from ultrafast laser oscillator, the repletion rate of the laser pulse can be reduced to any required value as shown in FIG. 3 to minimize/eliminate the cumulative heating effect and improve the machining quality. Alternatively a time gap is provided between groups of laser pulse to minimize the cumulative heating effect and improve the machining quality as sown in FIG. 4. Further the electro optic modulator serves as a shutter to on and off the ultrafast laser pulse when required. Further the electro optic modulator can be used to vary the pulse energy by varying the voltage applied to the electro optic modulator from the driver. Precise control of pulse energy/intensity control is very essential for varying the ablated feature size, selective material removal etc. A central processor controller controls the photo detector, driver of electro optic modulator, imaging system, XYZ stages and the galvanometer scanner as shown in FIG. 5.

Controlling the Laser Pulse by Acousto Optic Modulator

The acousto optic modulator may have the following specifications may be used to control the laser pulse from the ultrafast laser oscillator to minimize or eliminate the cumulative heating effect and to improve the machining quality.
Rise time: 5-100 ns
Efficiency: 70-95%
Clear aperture: 0.5-5 mm
Centre frequency/carrier frequency: 25 MHz to 300 MHz

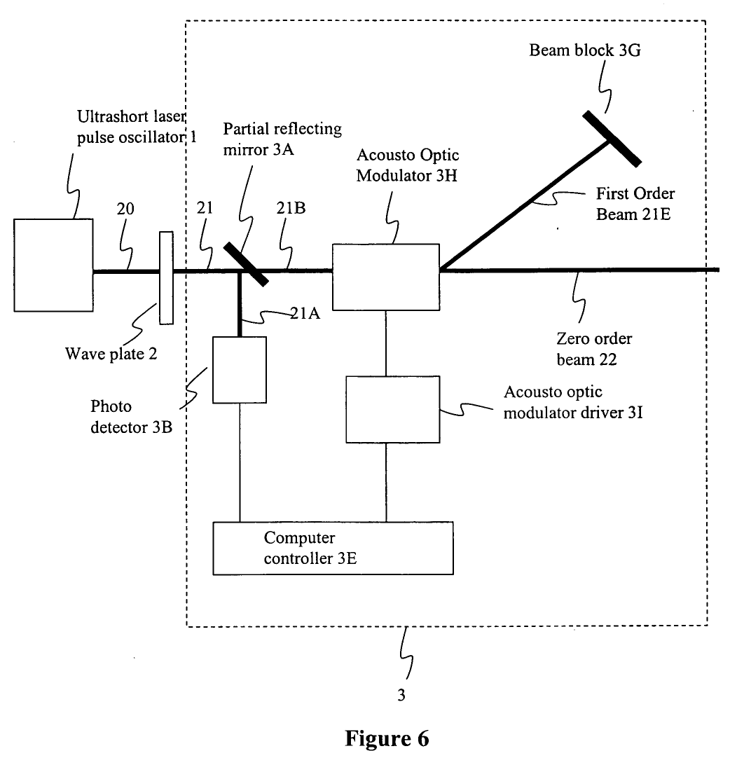

The laser pulse from the ultrafast laser oscillator passes through the Acousto optic Modulator (AOM) 3H, which is driven by a driver 31 as shown in FIG. 6. The ultrafast laser is split in to first order beam 21E and zero order beams 22, where the first order beam 21E is deflected at an angle call Bragg angle to the zero order beam 22 as shown in FIG. 6. The zero order beam 22 will have the same polarization state of the input beam 21B and the first order beam will have a polarization state 90 degree to the input beam 21B. Thus if the input beam 21B is P polarized the zero order beam 22 will be P polarized and first order beam 21E will be S polarized and vice versa.

The bragg angle is given by
θ=λf/v, where λ is the wavelength of the incident laser beam, f is the centre frequency/carrier frequency of the AOM and v is the velocity of the acoustic wave propagation in the in the acoustic crystal.

The first order beam 21E or zero order beam 22 can be used for laser processing and the other beam is blocked by the beam blocker 3G.

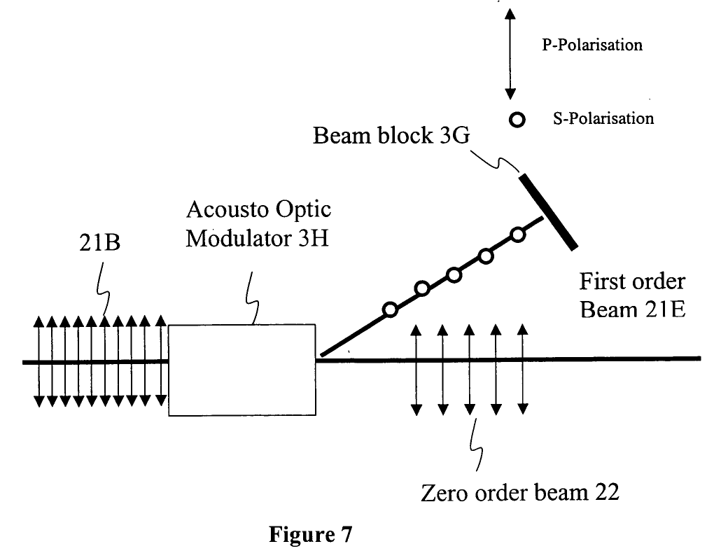

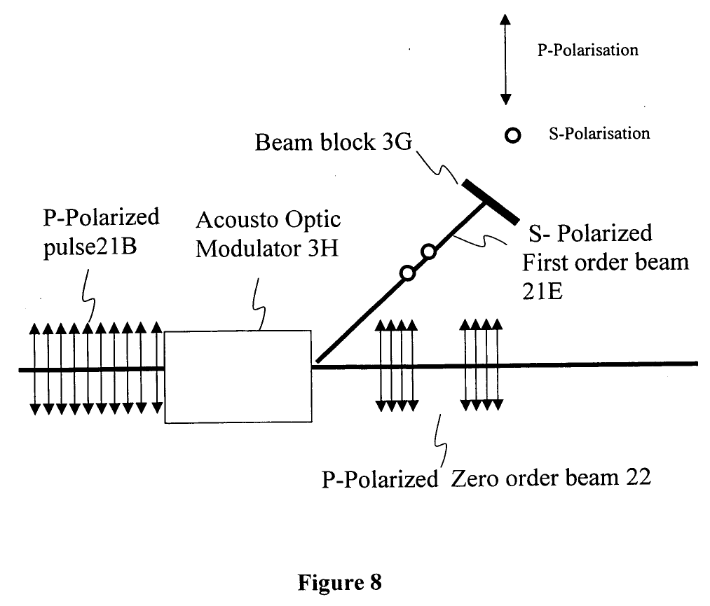

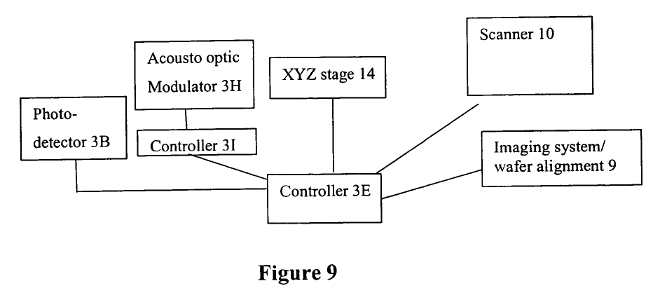

The ultrafast laser beam is a spectrum and the spectral width increases with the reduction in pulse width. On passing through the AOM 3H different wavelength in the laser spectrum will have a different bragg angle. Hence the first order beam 21E will disperse resulting in an elliptical shape of the laser beam, which will result in a poor beam quality and hence the machined feature quality. The dispersion effect reduces with the increase in the pulse width due to shorter spectral width and vice versa. Using the first or zero order beams for material processing may not be a problem above 1 ps pulse with but below 1 ps pulse width there will be serious deterioration of the beam quality. The zero order beam 22 has no dispersive effect and can be used for processing and the first order beam 21E can be blocked by beam blocking means 3G as sown in FIG. 6. By using Acousto optic modulator for controlling the laser pulse from ultrafast laser oscillator the repletion rate of the laser pulse can be reduced as shown in FIG. 7 to minimize/eliminate the cumulative heating effect and improve the machining quality. Alternatively a time gap between groups of laser pulse can be provided to minimize the cumulative heating effect and improve the machining quality as sown in FIG. 8. Further the acousto optic modulator serves as a shutter to on and off the ultrafast laser pulse when required. Also the electro optic modulator can be used to vary the pulse energy by varying the power applied to the Acousto optic modulator from the driver. Precise control of pulse energy/intensity control is very essential for varying the ablated feature size, selective material removal etc. A central processor controller controls the photo detector, driver of Acousto optic modulator, imaging system, XYZ stages and the galvanometer scanner as shown in FIG. 9.

Using Gas or Liquid Assist:

Use of assisted gas or liquid plays a vital role in ultrafast laser machining. It provides a mechanical force to eject the melt from the cut zone and cools the cut zone by forced conversion.

By using assisted gas or liquid for ablating a feature using laser pulse from ultrafast laser oscillator, the heat diffusion time is reduced due to the cooling effect of gas or liquid. Due to the reduction in the heat diffusion time it is possible to minimize the cumulative heating effect and improve the ablated feature quality even at high repletion rate. Thus by using assisted gas or liquid the minimal/no cumulative heating effect and quality machined feature can be obtained at repetition rate 2-10 times higher than at non gas assisted process. Also the efficiency and overall quality of the machining process can be improved by using assisted gas or liquid due to the interaction of the gas or liquid jet with the work piece. Also the gas or liquid assist the machining process by efficiently carrying the debris from the cutting channel. These assisted gases or liquid are delivered by single or multiple nozzle 12 at a pressure, which is determined by the substrate material, depth of cut, the type of nozzle used, distance of the nozzle 12 from the work piece 12 etc. In case of assisted gas, compressed gas from a gas tank is fed into the nozzle through a gas inlet where a pressure gauge was set. The gas pressure can be adjusted through a regulator installed upstream of the gas inlet. In case of liquid assisted cutting water or any other appropriate liquid is mixed with compressed air and sprayed at on the substrate at required pressure. The liquid pressure and ratio of liquid to air is controlled by a regulator. Generally the gas or liquid nozzles are positioned close the work piece as possible for minimizing the gas or liquid usage and improving the machining quality and efficiency. Some example of the gas used minimize the cumulative heating effect, improving the ablated feature quality and improve the machining efficiency are air, HFC, SF6, Nitrogen, Oxygen, argon, CF4, Helium, or a chlorofluorocarbon or halocarbon gas. The commonly used liquid assists are water, methanol, iso-propanol alcohol etc. Lower the viscosity of the liquid better will be the cutting quality and efficiency.

Scanning the Beam at High Speed:

By scanning the laser beam fast enough, so that each laser pulse irradiate at different spot. The scanning speed required to minimize the cumulative heating effect and increase the ablated feature quality depends on the focused spot size d, pulse energy Ep, scanning speed S, ablation threshold of material Eth and repletion rate of the system R.

The distance between the two consecutive spot D is given by
D=S/R

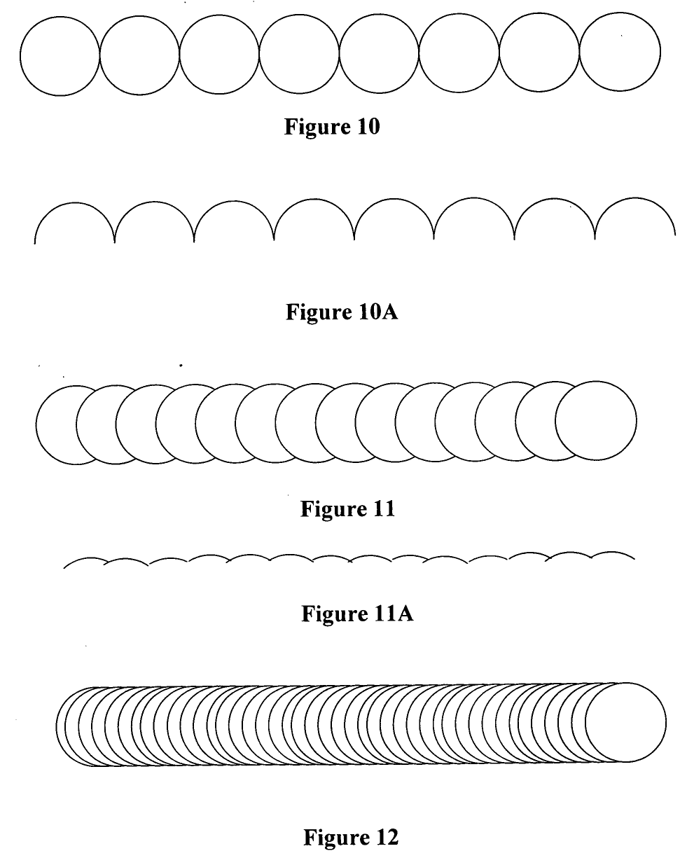

For example if the repletion rate of the system is 1 MHz and the scanning speed of 1000 mm/sec, the distance between the consecutive pulses is 1 μm. The overlap between the pulses Op will determine the edge quality of the ablated feature. The ablated feature Fd size can be as big as 2-3 times the focused spot size and as small as 1/20th focused spot size depending on the laser fluence/pulse energy and the material threshold. So if the ablated feature size Fd is 1 μm the consecutive pulse will have 0% overlap as sown in FIG. 10 hence there will be no cumulative heating effect present. But the edge quality will be bad if there is 0% overlap between the pulses as shown in FIG. 10A. Generally to obtain a uniform edge quality 50% or more over lap between the consecutive pulses is required. So in order to obtain 50% overlap as shown in FIG. 11, the scanning speed S should be reduced to 500 mm/sec. The resultant edge quality of the machined feature is as shown in FIG. 11A. The overlap between the pulses Op can be increased to 90% as sown in FIG. 12 by reducing the scanning speed to 100 mm/sec. The cumulative heating effect increases with the increase in the pulse to pulse overlap Op, but an overlap of 90% to 50% generally has minimal cumulative heating effect and better machining quality for most of the application. Generally maximum scanning speed of a commercially available galvanometer scanner is 3000-7000 mm/sec. Since it is very difficult to reduce the repletion rate of the of the laser pulse from the ultrafast laser oscillator below a certain limit due to the required resonator length, the scanning speed of the laser beam plays a very important role in improving the machining quality and reducing the cumulative heating effect. The repetition rate of the system Ro for a given pulse to pulse overlap Op is given by
Ro=S/(1−Op)X Fd

For example if the maximum scanning speed of the galvanometer scanner is 5000 mm/sec and ablated feature size is 1 μm the repletion rate of the pulse from ultrafast laser oscillator R can be as high as 50 Mhz for a pulse to pulse overlap Op of 90%. But if the maximum scanning speed of the galvonometer scanner is 1000 mm/sec then for same condition of 90% overlap the repletion rate R can be only 10 MHz. Thus the cumulative heating effect and the ablated feature quality can be controlled by varying the scanning speed for a given repletion rate of the system, the pulse to pulse overlap and ablated feature size.

Depending on the depth of the feature required the laser beam will be scanned along the same path few times at the optimal scanning speed. This mechanism of scanning at high speed is applicable for cutting a slot or via drilling by trepanning.

Machining Feature Size Below the focused Spot Size

In addition the, the present invention is capable of producing feature size of less than one twentieth of the focused spot size of the ultrafast pulse laser beam. This can be achieved by precisely controlling the laser threshold fluence slightly above the ablation threshold of the material and by precisely controlling the number of pulse and the duration between the pulses (minimizing or eliminating the cumulative heating effect) using the pulse modulation means disclosed in this invention.

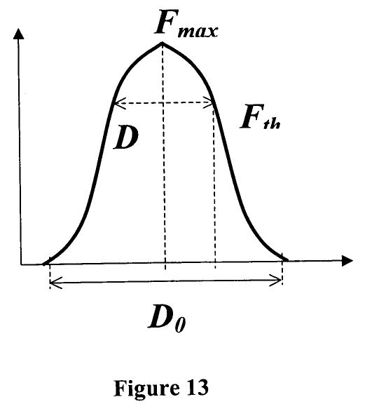

The energy distribution of machining spot follows a Gaussian profile, as sown in FIG. 13, thus, the fluence at any location of the spot F (x,y) can be calculated from the maximum fluence Fmax by

F(x,y)=Fmaxexp(−2(x2+y2)/(D/2)2), where D denotes the diameter of laser spot. Since the threshold Fth is precisely defined at ultrafast pulse width, only the portion of laser spot where f(x,y)>Fth will induce material removal. The above equation can be used to predict the size of ablated feature. To obtain a feature size 1/10th of the spot size, the maximum fluence Fmax must be controlled just 2% higher than the ablation threshold of the target material.

Also is difficult to obtain feature far below the focused spot size of the laser beam due to cumulative heating effect, which cause the damaged site to enlarge and hence difficult to machine sub micron and nano structures. As disclosed in this invention the cumulative heating effect can be minimized or eliminated by controlling the distance between the successive pulse or by varying the scanning speed of the laser beam or by using gas or liquid assist or any combination of the above. In addition the stability of the laser pulse from the ultrafast laser oscillator plays a vital role in machining feature of desired size with repeatability and precision. For every 1% variation in the laser fluence the feature size varies by 16% (which can be derived from a Gaussian equation). The pulse to pulse energy from the ultrafast laser oscillator is very stable due to fewer optical component, diode pumping, sealed optical components and environmentally (temperature, pressure) stabilization. Hence the laser fluence variation is very minimal, which enables to generate micro and nano scale feature with high repeatability and precision.

Pulse Energy:

Pulse energy plays a vital role in micro and nano processing with high quality.

Pulse energy is given by
Pe=Pavg/R, where Pavg is the average power of the laser and R is the repletion rate.

The pulse energy required to ablate a feature depends mainly on the threshold fluence of the material, feature size, maximum depth of the feature required.

Maximum Depth:

The maximum depth that can be generated for a given focused spot size of the laser beam depends on the pulse energy. As the ablated feature becomes deeper it is difficult to remove the ablated material from the hole and hence the ablated material absorbs the energy of the subsequent pulse. Thus the Depth limit exhibits a logarithmic dependence on the pulse energy.

Feature Size Repeatability:

The uncertainty in the feature size obtained will depend on the number of pulse required to ablate the required feature. Due to the topography generated and debris deposited in the crater by the ablation of the first pulse the absorption of the successive pulse is different due to the defects generated in the previous pulse, scattering of the laser beam etc. Due to the above mechanism the ablation threshold of the successive pulse may be vary. The uncertainly in the diameter of ablated feature increases with the increase in the number of laser pulse. More the number of pulse required for a given feture greater will be the uncertainty of feture size and hence the repeatability. Hence it is advantageous to higher pulse energy and lower number of pulse to ablate a required feature. An optimal pulse energy and number of pulse should be determined to ablate a feature of required specification.

Quality of the Ablated Feature:

Due to the change in the topography of the substrate and the debris deposited in the crater by the initial pulse the successive pulse will scatter and hence there is a change in the threshold fluence of the successive pulse. Higher pulse energy generates sufficient pressure for ejecting the debris out of the carter and hence the successive pulse can interact with the fresh substrate. This results in improved top surface and inner wall quality of the ablated feature.

Wavelength of the Laser Beam

In ultrafast laser processing the wavelength of the laser beam does not have a major impact on the threshold fluence of the material as in case of short pulse ablation in micron and nanosecond pulse width. Due to high peak power of the laser due to short pulse width, the protons are generated by the laser beam to start the ablation process rather than generated from the substrate. Hence absorption of the material at different wavelength does not have a major influence in its threshold fluence. Hence laser beam having the fundamental frequency having the wavelength preferably in the range of 700 nm to 1200 nm, will have higher cutting efficiency than the second harmonic frequency (frequency doubled) of 350 nm-600 nm for a given focused spot size due to the higher average power from the ultrafast laser oscillator at fundamental frequency. Fundamental laser frequency power will be 50% to 300% higher than the second harmonic frequency in the range of 233 nm to 400 nm and hence will have 50% to 300% higher material removal throughput.

Similarly, the laser beam having the second harmonic frequency having the wavelength preferably in the range of 350 nm to 600 nm, will have higher cutting efficiency compared to third harmonic frequency (Frequency tripled) due to the greater average power from the ultrafast laser oscillator at second harmonic frequency. Second harmonic laser frequency power will be 50% to 300% higher than the third harmonic frequency in the range of 233 nm to 400 nm and hence will have 50% to 300% higher material removal throughput.

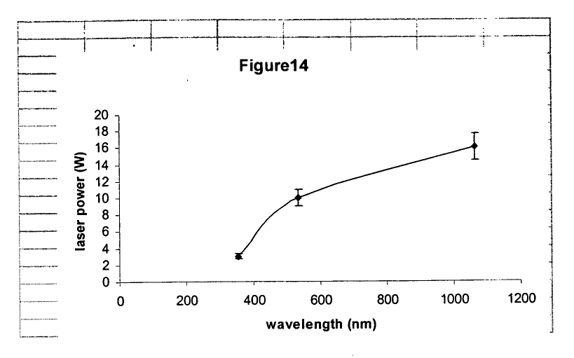

For example the average power out put at fundamental wave length at 1064 nm is 16 W for a picosecond laser model UPL-20-Lumera laser, the average power of second harmonic frequency at 532 nm wavelength is 10 W (FCS-532-Lumera laser) and the third harmonic frequency at 355 nm wavelength is 3 W (FCS-355-Lumera laser). Typical increase in laser power with the laser wavelength for ultrafast laser oscillator of picosecond pulse width is as shown in FIG. 14.

The stability of the laser beam will deteriorate with the reduction in wave length by frequency doubling and tripling, due to increase in the optical components and the sensitivity of the frequency doubling and tripling crystal to environmental factors such as temperature. This deterioration in the stability of the laser beam will lead to poor pulse to pulse energy stability and beam pointing stability. Hence repeatability in feature size and position accuracy may deteriorate compared to the fundamental frequency from the ultrafast laser oscillator by frequency doubling and tripling.

Hence the fundamental frequency will have better stability in terms of pulse to pulse energy and pointing stability compared to second harmonic frequency. Similarly the second harmonic frequency will have better stability in terms of pulse to pulse energy and pointing stability compared to third harmonic frequency. Also the cost of the system may increase by frequency doubling and tripling due to addition of more optical components.

In spite of the drawbacks of using frequency doubled and tripled laser pulse, some applications may demand the use of shorter wavelength to achieve smaller feature size and in sensitive material processing.

Resistor trimming of films and devices:

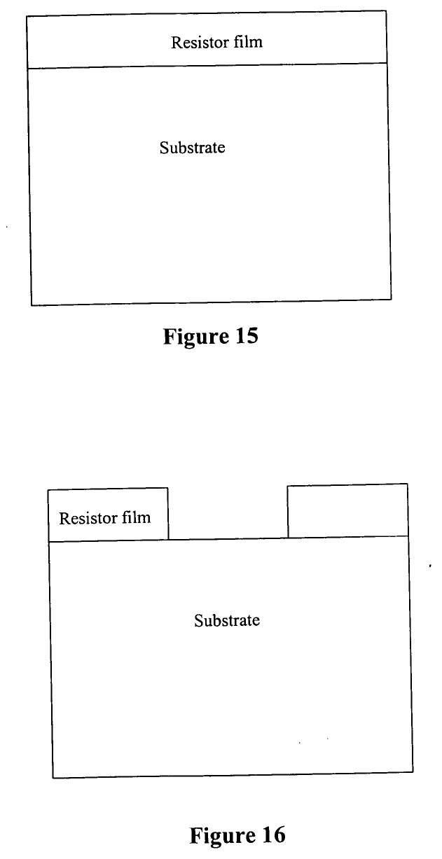

Of using Ultrafast laser pulse from the oscillator for resistor The method and apparatus of the present invention is capable of trimming resistor using ultrafast laser pulse from the oscillator. In ultrafast laser processing the threshold fluence of the material is clearly defined. Hence by controlling the pulsed laser fluence, the resistive material can be selectively removed without ablating the substrate, which is silicon, ceramic, glass material etc. FIG. 15 shows a typical cross section of resistive film structure, which consist of a film layer upon a substrate. The film layer is a resistive material such as nichrome, tantalum nitride, cesium silicide, silicon chromide, titanium, aluminum, nickel, copper, tungsten, platinum, gold, chromide, tantalum nitride, titanium nitride, cesium silicide, doped polysilicon, disilcide or polycide and the substrate material is silicon, ceramic material, germanium, indium gallium arsenide or semiconductor materials. The resistive film layer can be a thick film or a thin film layer depending on the application. FIG. 16 shows the trimming of resistive layer to the desired value without ablating or damaging the substrate material.

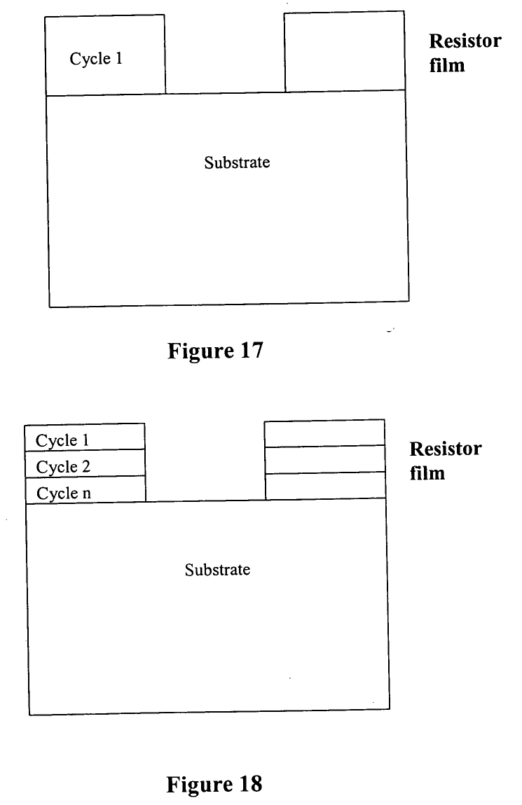

The overlying resistive layer can be removed in one scan cycle as shown in FIG. 17 or in multiple scan cycle as sown in FIG. 18 depending on the thickness of the resistive film, desired trim kerf, accuracy of trimming etc. The resistive layer can vary in thickness from few micrometers to few nanometers. The laser fluence of the resistive material depend on the material, thickness of the film, number of pulse at each scan point, scanning speed, focused spot size, repletion rate of the laser pulse, laser wavelength and the pulse width.

The resistor trimming process can be a passive processing or functional processing. In passive processing, the circuit elements are measured during or following each trimming operation and ceases when the predermined value is reached. Where in functional processing the whole device or circuit is activeated to its normal operating condition, and the device are adjusted by the laser to tune the resistance of the device.

Following are the advantage trimming application;
The threshold fluence of the material is precisely defied in ultrafast laser processing compared to nanosecond laser processing and hence the resistive layer can be ablated without ablating or damaging the underlying substrate.
Minimal or no heat affected zone due to short pulse with hence there is no device settling time is required between laser trim and functional measurement of the active devices and hence the overall processing time is reduced.
Due to the absence of micro crack there is minimal or no change in the resistance value with time and the device has long term stability.
Due to short pulse width, molten resistive material and debris are absent, which results in long term stability of resistor value and quality of laser trimming. No post processing may be required to remove the resistive molten material and debris.
Ultrafast laser ablation is not wavelength sensitive as nanosecond laser pulse ablation and hence not limited to certain wavelength range. Hence depending on the required spot size, speed, resistive film thickness the wavelength can be selected.
Due to the absence of heat affected zone, debris and molten material, there is no damage to the adjacent devices and hence the restriction on the device design could be eased (minimum space between components) and hence increase the compactness of the device, paving the way for smaller devices or circuits for both integrated circuit, or hybrid circuits. Also the number of device per wafer can be increased and hence the overall reduction in the cost of manufacturing of the devices.
The ablated feature size and hence the trim kerf can be precisely controlled using laser pulse from ultrasft laser oscillator compared to nanosecond laser pulse and hence uniform trim kerf can be obtained. This results in precise control and post determination of resistor values.

Polarization conversion module:

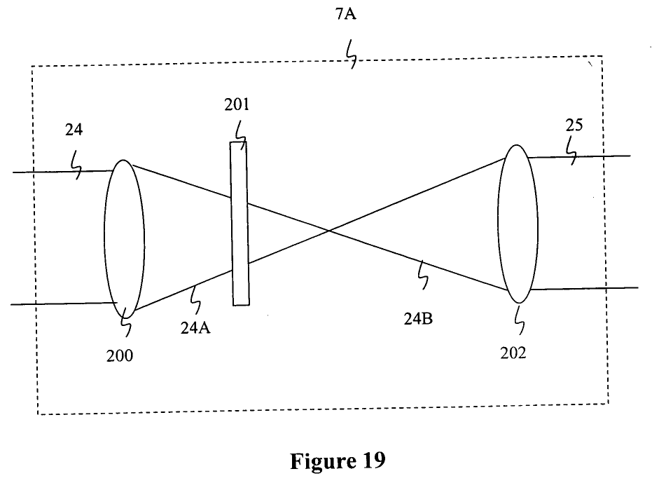

The laser beam 24 is passed through a polarization conversion module 7A to change the polarization state of the laser beam along the axis of the laser beam profile. In FIG. 19, a novel yet simple technique is proposed for radial polarization modulation. The first biconvex lens 200 focuses the collimated laser beam into a tightly convergent beam 24A. As illustrated in FIG. 19, light rays of a convergent beam travel different optical path lengths when they transmit to a birefringent/retardation plate plate 201. The retardation plate 201 can be a half-wave plate or a quarter-wave plate. The light rays at the central part of the beam travel a shorter distance than those at the edge. Consequently, the polarization state is partially or completely modulated into radial, depending on the beam convergence and properties of the birefringent plate. The laser beam 24B is collimated by the lens 202. The lens 200 and 202 can be of the positive type or negative type lens and may be combined like a telescope. It was found that the polarization converted beam by the polarization conversion module significantly improves the machining quality and throughput. By converting the polarization state of the beam by the polarization convertion module 7A there are significant advantages. There is a significant reduction in debris generated due to ablation. There is a reduction in the focused beam spot size by 10-30% compared to linear or circular polarization states. There is an increase in the machining efficiency by 10-30% compared to linaer or circular polarization states.

Scanning module:

The scanning module 10 can be a galvo scanner or a piezo scanner. The scanning module scans the laser beam in two axes. A piezo scanner is preferred over a galvo scanner. There is a higher scanning speed and hence improved machining quality and efficiency. There is higher positioning accuracy and resolution. There is also a minimization of the cumulative heating effect due to higher scanning speed. Lastly, there is a common pivot point, and field distortion at the image plane is avoided. Hence, it does not require compensation software to eliminate the distortion.

Beam shaping module:

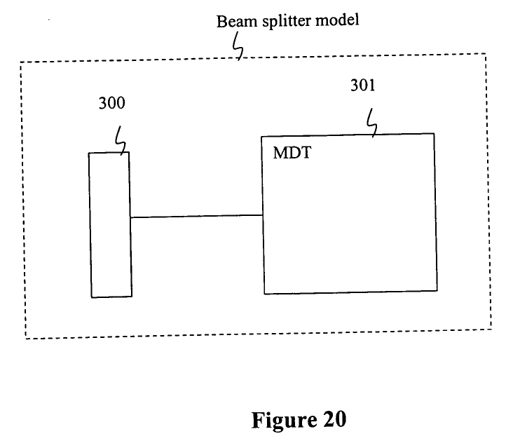

The beam shaping module is introduced to change the profile of the laser beam to a hat top or any other profile required. The beam shaping module is as shown in FIG. 20, and it preferably includes a quarter wave plate 300 and a MDT crystal 301. The MDT element is relatively cheap compared to beam shapers, consisting of several micro lens or diffractive optics. The MDT element is based on the phenomenon of internal conical reflection, and the resultant beam profile depends on the diameter and wavelength of the incoming beam and the length of the MDT element. By varying the diameter and length of the MDT element, different beam profiles are possible. The beam shaping module can be placed after the polarization conversion module, or it can be absent depending on the application.

The invention has been described with reference to exemplary embodiments. However, it will be readily apparent to those skilled in the art that it is possible to embody the invention in specific forms other than those of the embodiments described above. This may be done without departing from the sprit of the invention. The exemplary embodiments are merely illustrative and should not be considered restrictive in any way. The scope of the invention is given by the appended claims, rather than the preceding description, and all variations and equivalents which fall within the range of the claims are intended to be embraced therein.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A laser maching method for trimming a resistor film from an intial value to a desired value using ultrafast laser pulse from ultrafast laser oscillator comprising the step of;
placing a resistor film on a substrate;
emitting a pulsed laser beam from ultrafast laser oscillator;
modulating the laser pulse, in order to minimize the cumulative heating effect and improve the machining quality;
expanding or reducing the beam to vary the diameter of the laser beam in one or two axis and hence the diameter of the focused spot size;
converting the polarization of the laser beam;
improving beam quality;
scanning the laser beam in two axes; and
focusinng the pulsed laser beam on to the resistor film on the substrate;
wherein the resistor film material is ablated within the target area of the resistor to change its initial value to the desired value.

2. A method according to claim 1 which further includes the step of changing the polarization state of the laser beam.

3. A method according to claim 1 which further includes the step of moving the wafer in three dimensions.

4. A method according to claim 1 which further includes the step of injecting a liquid or gas to assist in reducing the cumulative heating effect.

5. A method according to claim 1 which further includes the step of controlling the scanning speed.

6. A method according to claim 1 which further includes the step of imaging the laser beam in order to align the laser beam with the wafer and to monitor the machining process.

7. A method according to claim 1 which further includes the step of using a longer or shorter wavelength laser beam depending on the thickness of the resistor film and required resistor trimming accuracy.

8. A method according to claim 1 which further includes the step of controlling the laser pulse energy and the pulse number.

9. A method according to claim 1 which further includes measuring the resistor value of the device while ablating the resistor film by ultrafast laser pulse from oscillator.

10. A method according to claim 1 which further includes determining whether further ablation of resistor film is required to change the resistor value to the desired value.

11. A method according to claim 1 which further includes terminating resistor trimming upon reaching the desired value by turning off the laser pulse from reaching the target surface through pulse modulator.

12. A method according to claim 1 which further includes the step of changing the shape of the laser beam to improve the machining efficiency and quality.

13. A method according to claim 1 which further includes the step of reducing the ablated feature size below the focused spot size by controlling the laser threshold fluence.

14. A method according to claim 1 wherein the work piece is a semiconductor wafer.

15. The method according to claim 1, which further includes for aligning the work piece to the focused laser beam and to monitor the laser trimming process.

16. A method according to claim 1, wherein;
overlying resistor layers can be removed in a single cycle or in multiple cycles by controlling the laser fluence; and
the thickness of the resistor film on the substrate vary from few micrometers to few nanometers.

17. The method of claim 1, wherein the measured resistor value is compared with the predetermined resistor value and the need for additional ultrafast laser trimming is determined.

18. A laser maching apparatus for trimming a resistor film from an intial value to a desired value using ultrafast laser pulse from ultrafast laser oscillator comprising the step of;
a resistor film on a substrate;
a laser source that emits a pulsed laser beam from ultrafast laser oscillator;
modulating means for controlling the laser pulse, minimize the cumulative heating effect and improve the machining quality;
bam expanding or reducing means for varying the diameter of the laser beam in one or two axis and hence the diameter of the focused spot size;
means for polarization conversion;
means for improving beam quality;
scanning means for scanning the laser beam in two axes; and
focusing means for focusing the pulsed laser beam on to the resistor film on the substrate;
wherein the resistor film material is ablated within the target area of the resistor to change its initial value to the desired value.

19. The apparatus of claim 18,
wherein the laser source includes a diode pumped or CW laser pumped solid state ultrafast laser oscillator preferably of pulse width ranging from 1 fs to 100 ps, pulse energy 1 nanojoule-100 microjoule and the pulse repletion rate in a range of 1 MHz to 400 MHz;
wherein the repetition rate can be reduced and pulse energy can be increased by increasing a cavity length inside the ultrafast laser oscillator;
wherein the cumulative heating effect can be minimized and machining quality of the resistor trimming is improved with a reduction in the repetition rate of the laser pulse from the ultrafast laser oscillator.

20. The apparatus of claim 18;
wherein the wavelength of the laser beam from the ultrafast laser oscillator is preferably a fundamental frequency of 700 nm-1200 nm wavelength or a second harmonic of the fundamental frequency of 350 nm-600 nm wavelength or a third harmonic of the fundamental frequency of 233 nm-400 nm wavelength;
wherein the laser beam from the ultrafast laser oscillator preferably has the following characteristics;
a pointing stability of the beam is less than 100 μrad/100 nm;
a laser stability less than ±1%;
laser noise less than ±1%;
laser beam divergence of less than 4 mradian; and
a spatial mode TEM₀₀ of M² less than 2.

21. The apparatus of claim 18, which further includes polarization conversion means including;
a polarization plate that is placed in-between a telescopic module to change the polarization state of the laser beam along the axis of the beam;
wherein the laser beam at the central part travels a shorter distance in the polarization plate than those at the edge due to the divergence or convergence of the laser beam;
wherein the polarization state of the laser beam is different, along the axis, at different portions of the laser beam profile due to a different distance traveled through the polarization plate;
wherein the telescopic module can be of the keplerian telescope type, having two positive lenses or of the Galilean telescope type, having a positive and negative lens;
wherein the polarization plate is selected from a group including a half wave plate or a quarter wave plate or retardation plate or birefringent plate or a combination of half wave and quarter wave plate;
wherein the polarization state of the resultant laser beam from the polarization conversion means can be a partly or completely radially polarized.

22. The apparatus of claim 21 which further includes a polarization module for providing a resultant polarization state of the laser beam that results in;
a reduction in the focused machined feature size and spot size of the laser beam compared to linear or circularly polarized laser beam by 5-40%;
minimizes the debris surrounding the ablated area and hence the quality of resistor trimming compared to linearly or circularly polarized laser beams; and
increases the machining efficiency or ablation rate of the resistor trimming process by 10-50% compared to linearly or circularly polarized laser beams.

23. The apparatus of claim 18, wherein the pulsed laser beam from the ultrafast laser oscillator is modulatd by an electro optic modulator or an acousto optic modulator, which are driven by respective drivers to minimize the cumulative heating effect and to improve the quality of resistor trimming.

24. The apparatus of claim 23, wherein the electro optic modulator and acousto optic modulator serve as a laser shutter to turn on and off the laser pulse from the ultrafast laser oscillator when required.

25. The apparatus of claim 23, which further includes a photo detector that is placed before the electro optic modulator or acousto optic modulator means to obtain a signal and to synchronize the on/off signal to the electro optic modulator to avoid any clipping of the laser pulse.

26. The apparatus of claim 23, wherein the repletion rate of the laser pulse from ultrfast laser oscillator is reduced by modulating the laser pulse by electro optic modulator or acousto optic modulator means to minimize or eliminate the cumulative heating effect and improve the machining quality of resistor trimming.

27. The apparatus of claim 23, wherein a time gap is provided between groups of laser pulses from the ultrafast laser oscillator resulting from modulating the laser pulse by electro optic modulator or acousto optic modulator means to minimize the cumulative heating effect and improve the machining quality of resistor trimming.

28. The apparatus of claim 23, wherein by modulating the laser pulse ultrafast laser oscillator by electro optic modulator or acousto optic modulator means the laser pulse from the can be transmitted or blocked when required.

29. The apparatus of claim 23, wherein the pulse energy of the laser beam from the ultrafast laser oscillator is controlled by varying the power applied to the electro optic modulator or acousto optic modulator from the electro optic driver or acousto optic driver respectively.

30. The apparatus of claim 23,
wherein the electro optic modulator is used in combination with a polarizing beam splitter or polarizer or prism for modulating the laser pulse;
the electro optic modulator is preferably includes pockels cells or a Q-switch or a pulse picker;
wherein the electro optic modulator has the following characteristics;
a short rise time in the range of 20 ns to 10 ps;
an energy/power loss less than 10%; and
a clear aperture diameter of 1-10 mm;
wherein an antireflection coating and type of crystal in the modulator depend on the laser wavelength, pulse width and energy;
wherein the electro optic modulator is driven by a driver which can be computer controlled;
wherein the electro optic modulator is driven by the driver by sending a trigger signal, which is preferably a power or voltage signal, which shifts the polarization state of the laser beam on passing through the electro optic modulator from horizontal to vertical polarization or vice versa.

31. The apparatus of claim 30;
wherein changing the polarization the pulse in the electro optic modulator will be transmitted or deflected by the polarizing beam splitter or a polarizer or prism, thus acting like a high speed shutter and modulating the laser pulse from the ultrafast laser oscillator;
wherein the transmitted beam can be used for ultrafast pulsed laser processing and the deflected beam is blocked by the beam blocking means and vice versa.

32. The apparatus of claim 23, wherein the electro optic modulator can change the polarization state of any individual pulse or a group of pulses from the ultrafast laser oscillator by 90 degrees to horizontal or vertical polarization state depending on the polarization state of the input pulse.

33. The apparatus of claim 23, wherein the acoustic optic modulator has the following characteristics;
a rise time of 5-10 ns;
an efficiency of 50-95%;
a clear aperture of 0.5-5 mm;
a center frequency/carrier frequency of 25 MHz to 300 MHz.

34. The apparatus of claim 23;
wherein the acousto optic modulator is driven by the driver by sending a trigger signal, which is preferably a power or voltage signal, splits the ultrafast laser beam in to first order and zero order beams, where the first order beam is deflected at an angle called the Bragg angle to the zero order beam;
wherein the zero order beam will have the same polarization state of the input beam and the first order beam will have a polarization state 90 degrees to the input beam;
wherein the first order or zero order beam can be used for laser processing and the other beam is blocked by a beam blocking means and thus acting like a high speed shutter and modulating the laser pulse from ultrafast laser oscillator.

35. The apparatus of claim 34, wherein the zero order beam has no dispersive effect and used for material processing and the first order beam is blocked by a beam blocking means.

36. The apparatus of claim 23, wherein the ablation of the resistor film is controlled by the acousto optic modulator or electro optic modulator depending on the feed back from the device measuring the resistor value of the device while ablating.

37. The apparatus of claim 23, wherein the laser beam ablates the resistor film till the resistor value reaches the nominal value.

38. The apparatus of claim 18, wherein the modulated ultrafast laser beam is expanded or reduced in beam diameter in one or two axis of the laser beam by beam expansion or reducing means of keplerian telescope type, including two positive lenses or of the Galilean telescope type, including positive and negative lenses.

39. The apparatus of claim 18, which further includes beam quality improving means including a diaphragm of the type having an Iris diaphragm.

40. The apparatus of claim 18, may have a pulse modulation/control means in the laser source and may nor require an external acousto optic modulator or elcetro optic modulator.

41. The apparatus of claim 18, wherein a one axis or two axis galvanometer scanner or a piezo scanner means scans the laser beam across the resistor film in any desired shape.

42. The apparatus of claim 41, wherein the piezo scanner that avoids pillow shaped field distortion at the image field due to common pivot points.

43. The apparatus of claim 18;
wherein the pulsed laser beam is focused on the resistor film substrate by a focusing means of type having an objective lens or telecentric or f-Theta lens or confocal microscopy lens or the like;
wherein the focusing means positioned at a distance from the scanning mirror approximately equal to the front focal length (forward working distance) of the focusing means and the work piece is positioned at approximately the back focal length (back working distance) of the focusing means.

44. The apparatus of claim 18, wherein the work piece/substrate is moved with respect to the laser beam by a translation table means.

45. The apparatus of claim 18, which further comprises a beam shaping means to change the shape of the beam profile at the focused spot size;
wherein the beam shaping means is of the type having a monoclinic double tungstate MDT element based on the phenomenon of internal conical reflection;
wherein the beam shaping is obtained by the combination of a quarter wave plate and the MDT element;
wherein the resultant beam profile depends on the diameter and wavelength on the incoming laser beam and the length of the MDT element;
wherein a flat top beam profile can be generated at the focal plane;
wherein flat bottom holes/trench can be generated;
wherein the effieciency of beam shaping is high due to the transitive efficiency of the MDT material and minimal optical elements involved; and
wherein the machining efficiency and quality of machining is improved due to beam shaping.

46. The apparatus of claim 18, which further includes pulse modulating means, two axis galvanometer or piezo scanning means and a translation table means that are controlled by a central processor control means.

47. The apparatus of claim 18, further comprises scanning strategy control means for controlling at least one of the incident laser beam power, pulse repetition rate, duration between successive pulse or a group of pulses and a galvanometer or piezo scanning speed during resistor trimming on the work piece/substrate.

48. The method of claim 18, wherein the cumulative heating effect is minimized, machining quality of resistor trimming is improved and machining speed is increased using gas or liquid assist means;
wherein the gas is applied at a pressure through a nozzle;
wherein the liquid is mixed with compressed air and applied at a pressure through a nozzle;
wherein single or multiple nozzles may be used depending on the application;
wherein the gas or liquid nozzle is placed close to the work piece surface;
wherein the gas assist may be air, HFC, SF₆, Nitrogen, Oxygen, argon, CF₄, Helium, or a chlorofluorocarbon or halocarbon gas; and
the liquid assist may be water, methanol or iso-propanol alcohol.

49. The apparatus of claim 18, wherein the film layer is a resistive material such as nichrome, tantalum nitride, cesium silicide, silicon chromide, titanium, aluminum, nickel, copper, tungsten, platinum, gold, chromide, tantalum nitride, titanium nitride, cesium silicide, nickel chromium compound, ruthenium oxide, tantalum nitride compound, doped polysilicon, disilcide or polycide.

50. The apparatus of claim 18, wherein the substrate material is silicon, ceramic material, germanium, indium gallium arsenide or semiconductor materials.

51. The apparatus of claim 18, wherein a spatial machining resolution of less than one-twentieth of a cross-sectional diameter of the pulsed laser beam from the ultrafast laser oscillator in a focused state at the surface of the resistor film can be achieved.

52. An apparatus for ablating a feature smaller then the focused spot size of the pulsed laser beam from an ultrfast laser oscillator of a pulse repetition rate of 1 MHZ to 400 MHZ, comprising;
means for controlling the laser threshold fluence slightly above the ablation threshold of the material;
means for controlling the number of pulses and the duration between the pulses for minimizing or eliminating the cumulative heating effect, using pulse modulation means; and
wherein a spatial machining resolution of less than one-twentieth of a cross-sectional diameter of the pulsed laser beam in a focused state at the surface of the work piece is obtained.

53. The apparatus of claim 18, wherein the cumulative heating effect is minimized, quality of resistor trimming is improved and machining efficiency is improved by controlling the scanning speed of a laser beam from the ultrafast laser oscillator of pulse repetition rate 1 MHZ to 400 MHZ;
wherein the optimal scanning speed to minimize the cumulative heating effect, improve the resistor trimming efficiency and improve the resistor trimming quality depend on the repletion rate of the laser beam, the ablated feature size and a type of gas or liquid assist used.

54. The apparatus of claim 18 further comprises means to improve the ablation efficiency and feature size repeatability;
wherein a pulsed laser beam from the ultrafast laser oscillator having the fundamental frequency having the wavelength in the range of 700 nm to 1200 nm, will have 50% to 200% higher resistor trimming efficiency than the second harmonic frequency of 350 nm-600 nm from the ultrafast laser oscillator due to the higher laser power; and
wherein a pulsed laser second harmonic frequency from the ultrafast laser oscillator having the wavelength in the range of 350 nm to 600 nm, will have 50% to 200% higher resistor trimming efficiency compared to third harmonic frequency from the ultrafast laser oscillator of 233 nm-400 nm due to the first laser power.

55. The apparatus of claim 54;
wherein the fundamental frequency from ultrafast laser oscillator has better laser stability position accuracy and feature size repeatability than the second harmonic frequency from an ultrafast laser oscillator due to increased optical components and sensitivity of the frequency conversion crystal; and
wherein the second harmonic frequency from the ultrafast laser oscillator has better laser stability, position accuracy and feature size repeatability than the third harmonic frequency from the ultrafast laser oscillator due to increased optical components and sensitivity of the frequency conversion crystals.

56. The apparatus of claim 18, wherein the ultrafast laser oscillator can be a fiber oscillator amplifier of repetition rate greater than 1 MHZ.

57. The apparatus of claim 18, wherein debris is loosely bound to the surface of the work piece and can be removed while machining using pressurized gas assist and hence the process may not require post processing.

58. The apparatus of claim 18, wherein the resistor film is a thin film or a thick film resistor.

59. The apparatus of claim 18, wherein the resistor film is a thin film and thick film hybrid resistor.

60. The apparatus of claim 18, wherein the pulse modulating means, scanning means, resistor measuring device and the translation table means are controlled by central processor control means.

61. The apparatus of claim 18, the resistive layer or film is selective removed by laser pulse from ultrafast laser oscillator wherein;
a layer of material can be selectively removed without ablating the underlying material by precisely controlling the pulsed laser fluence;
the resistor trimming can be of any desired shape depending on the application;
overlying resistive layer can be removed layer by layer or few layers together by controlling the laser fluence;
each layer can vary in thickness from few micrometers to few nanometers; the laser fluence of the material depend on the material, number of pulse at each scan point, scanning speed, focused spot size, repletion rate of the laser pulse, laser wavelength and the pulse width;

62. The apparatus of claim 18, wherein resistor trimming using ultrafast laser pulse has miminal or no microcracks formed on the substrate, that cause resistor value drift from normal value.

63. The apparatus of claim 18, wherein ultrafast laser ablation is very sensitive to wavelength and hence not limited to certain wavelength range depending on the resistor film material and substrate material, hence depending on the required spot size, speed, resistive film thickness the wavelength is selected.

64. The apparatus of claim 18, wherein resistor trimming using ultrafast laser pulse has minimal or no heat affected zone, debris and molten material and there is no damage to the adjacent devices and hence the restriction on minimum space between components is eased and hence increase the compactness of the device, paving the way for smaller devices or circuits for both integrated circuit, or hybrid circuits.

65. The apparatus of claim 64, wherein the number of device per wafer can be increased and hence the overall reduction in the cost of manufacturing of the devices.

66. The apparatus of claim 18, wherein the ablated feature size and hence the trim kerf can be precisely controlled using laser pulse from ultrafast laser oscillator, hence uniform trim kerf can be obtained, which results in precise control and post determination of resistor values.

67. The apparatus of claim 18, wherein there is minimal or no heat affected zone due to short pulse width of ultrafast laser beam hence no device settling time is required between laser trim and functional measurement of the active devices and the overall processing time is reduced.

68. The apparatus of claim 18, wherein molten resistive material and debris are minimal or absent, due to short laser pulse width which results in long term stability of resistor value and quality of laser trimming and hence minimal or no post processing may be required to remove the resistive molten material and debris.
